(19) United States
(12) Patent Application Publication
(10) Pub. No.: US 2014/0269171 A1
(43) Pub. Date: Sep. 18, 2014

(54) SEISMIC STREAMER SYSTEM

(71) Applicant: Westerngeco L.L.C., Houston, TX (US)

(72) Inventor: KENNETH E. WELKER, OSLO (NO)

(73) Assignee: Westerngeco L.L.C., Houston, TX (US)

(21) Appl. No.: 14/049,032

(22) Filed: Oct. 8, 2013

Related U.S. Application Data
(60) Provisional application No. 61/787,886, filed on Mar. 15, 2013.

(51) Int. Cl. G01V 1/38

(52) U.S. Cl. CPC G01V 1/3808
USPC 367/15

(57) ABSTRACT

A method of performing a marine survey is provided. The method may include deploying, into a body of water, a towable streamer including one or more sensors for performing a subterranean survey. The method may also include receiving, from the sensors, information relating to the subterranean survey at a data storage device housed within a portion of the towable streamer. The method may also include storing the information within the data storage device.

### CROSS-REFERENCE TO RELATED APPLICATION

This application claims the benefit of U.S. Provisional Patent Application Ser. No. 61/787,886 filed Mar. 15, 2013, which is incorporated herein by reference in its entirety.

### BACKGROUND

Seismic data acquisition may be conducted by towing some number of streamer sections behind a vessel. The streamer sections may have varying types of construction and sensor mounting in the streamer. Data recorded on these streamers are stored in memory on the towing vessel.

Ocean bottom cable (OBC) is another recording body used in seismic data acquisition. OBC differs from towed marine because the cables remain stationary on the sea floor and the data may be recorded either on a dedicated recording buoy or a recording vessel.

In both cases the length of cable sections is on the order of 100 m. The sections are connected together to make streamer lengths of up to 12 km. Cables of this length require electrical power to record and transmit data along the length of the cables. Further, the recording systems dedicated to store the acquired seismic data are complex and require well trained seismic observers to manage the acquisition and perform quality control of the data.

OBC surveys are between 3 and 5 times as expensive as towed marine surveys due to the time required to acquire the data. A vessel and trained crew is needed to deploy the cable and attach the data and power transmission cable to a buoy to be ready for data recording. This may take a considerable amount of time.

Towed marine streamer spreads may consist of between 6 and 12 streamers and are seldom shorter in length than 3 km. The large size of these spreads makes controlling the streamer locations difficult especially in the presence of ocean currents. This lack of control results in difficulty in maneuvering near stationary production platforms.

### SUMMARY

In one implementation, a method of performing a marine survey is provided. The method may include deploying, into a body of water, a towable streamer including sensors for performing a subterranean survey. The method may include receiving, from the sensors, information relating to the subterranean survey at a data storage device housed within a portion of the towable streamer and storing the information within the data storage device.

In some implementations, the data storage device may be removably attached to the towable streamer. The data storage device may include a cylindrical housing. The information may be received from a particle motion sensor. The sensors may include depth sensors, acoustic sensors, and seismic sensors. The towable streamer may include a portion having a rigidity greater than that of a less rigid portion of the towable streamer. The towable streamer may have a length of 30 meters or less. In some implementations, deploying the towable streamer may include one of deploying the streamer towed by a sea vessel and deploying a seabed cable laid on a sea floor.

In another implementation, a marine survey apparatus is provided. The marine survey apparatus may include a towable streamer affixed to a vessel and deployed into a body of water. Sensors may be attached to the towable streamer, the sensors able to receive information associated with a subterranean survey. A data storage device may be housed within a portion of the towable streamer. The data storage device may store the information associated with the subterranean survey.

In some implementations, the data storage device may include an attachment mechanism that may removably attach the data storage device to the towable streamer. The attachment mechanism may include a screw fitting. The towable streamer may include a portion having a rigidity greater than that of a less rigid portion of the towable streamer. The rigid portion may be external to the towable streamer. The towable streamer may have a length of 30 meters or less.

In another implementation, a data storage device for use in a marine survey is provided. The data storage device may include a housing having an attachment mechanism that may removably attach the housing to a streamer. The data storage device may include a processor that may receive information associated with a subterranean survey from sensors, the processor may be included within the housing. The data storage device may include a memory device included within the housing, the memory device may store the information associated with the subterranean survey.

In some implementations, the processor may enable underwater high speed communications between the data storage device and a second device. The housing may include a wet-mateable connector that may interface with the streamer. The housing may be cylindrical and may have a diameter no larger than a diameter of the streamer. The streamer may be positioned as vertically deployed, horizontally deployed or towable. The data storage device may include a battery to store wave motion generated power.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of the present disclosure are described with reference to the following figures.

FIG. 1 illustrates a sea vessel that may deploy one or more streamers in accordance with one or more embodiments of the present disclosure;

FIG. 2 illustrates a portion of a streamer in accordance with one or more embodiments of the present disclosure;

FIG. 3 illustrates an example of a data storage device in accordance with one or more embodiments of the present disclosure;

FIG. 4 illustrates an example of a data storage device affixed to a streamer in accordance with one or more embodiments of the present disclosure;

FIG. 5 illustrates an example of a data storage device in accordance with one or more embodiments of the present disclosure; and

FIG. 6 is a flow diagram of a process in accordance with one or more embodiments of the present disclosure.

Like reference symbols in the various drawings may indicate like elements.

### DETAILED DESCRIPTION

Embodiments provided herein are directed towards a data storage device that may be connected inline with a streamer section and/or incorporated into a streamer section to allow for data acquisition. The streamer section may include fewer channels than are typical for towed marine or conventional OBC allowing for lower power and data storage requirements. In some embodiments, the data storage device may include a small self contained recording system, which may be in communication with an associated cable housed sensor system. This arrangement may enable control of any undershoot cables and semi-permanent deployment of ocean bottom cables with multiple channels without requiring highly trained seismic acquisition personnel.

FIG. 1 illustrates a sea vessel 100 that may include a reel or spool 104 for deploying a streamer 102, which may be a cable-like structure having a number of sensors 103 for performing a subterranean survey of a subterranean structure 114 below a sea floor 112. A portion of streamer 102, and more particularly, sensors 103, may be deployed in a body of water 108 underneath a sea surface 110. Streamer 102 may be towed by the sea vessel 100 during a seismic operation.

In an alternative implementation, instead of using a streamer that is towed in the water by sea vessel 100, a seabed cable may be used instead, where the seabed cable may be, for example, deployed from a reel on the sea vessel and/or laid on a sea floor 112.

In yet another implementation, the data storage device may be associated with a streamer that may be deployed vertically from either a buoy, stationary underwater or surface autonomous vehicle, and/or a structure rising up from the sea floor. This type of arrangement may be referred to as a vertical cable survey. Accordingly, this type of arrangement may render recording buoys and surface connections unnecessary.

In the following, the term “streamer” is intended to cover either a streamer that is towed by a sub sea or sea surface vessel or non-towable streamers such as a seabed cable laid on the sea floor 112 or those that may be deployed vertically in the water column.

In some embodiments, streamer 102 may have a length of 15 m-100 m (e.g., 30 meters or less). However, it should be noted that streamers of any length may be used without departing from the scope of the present disclosure.

Also depicted in FIG. 1 are a number of signal sources 105 that may produce signals propagated into the body of water 108 and into subterranean structure 114. The signals may be reflected from layers in subterranean structure 114, including a resistive body 116 that can be any one of a hydrocarbon-containing reservoir, a fresh water aquifer, an injection zone and so forth. Signals reflected from resistive body 116 may be propagated upwardly toward sensors 103 for detection by the sensors. Measurement data may be collected by sensors 103, which may store the measurement data and/or transmit the measurement data back to data storage device 106.

In some embodiments, sensors 103 may be seismic sensors, which may be implemented with acoustic sensors such as hydrophones or geophones or fiber optic based sensor systems. The signal sources 105 may be seismic sources, such as air guns, marine vibrators and/or explosives. In an alternative implementation, the sensors 103 may be electromagnetic (EM) sensors 103, and signal sources 105 may be EM sources that generate EM waves that are propagated into subterranean structure 114.

Although not shown in FIG. 1, streamer 102 may further include additional sensors (e.g., depth sensors), which may be used to detect a position of respective sections of streamer 102. In accordance with some embodiments, data from these additional sensors may be sent back to data storage device 106 to update information regarding which sections of streamer 102 are in body of water 108, and which sections of streamer 102 are outside the body of water.

In some embodiments, streamer 102 may include any number, type and configuration of sensors. Some of these may include, but are not limited to, hydrophones, geophones, particle displacement sensors, particle velocity sensors, accelerometers, pressure gradient sensors or combinations thereof.

In some embodiments, streamer 102 may include a multi-component streamer, which means that streamer 102 may contain particle motion sensors and pressure sensors. The pressure and particle motion sensors may be part of a multi-component sensor unit. Each pressure sensor may be configured to detect a pressure wavefield, and each particle motion sensor may be configured to detect at least one component of particle motion that is associated with acoustic signals that are proximate to the sensor. Examples of particle motions include one or more components of a particle displacement, one or more components (inline (x), crossline (y) and vertical (z) components of a particle velocity and one or more components of a particle acceleration. A more thorough discussion of particle motion sensors may be found in U.S. Patent Publication 2012/0082001, which is incorporated by reference herein in its entirety.

FIG. 2 shows one particular embodiment depicting an example of a portion of streamer 102, including sections 200A, 200B, and 200C. In this particular embodiment, section 200A may include a corresponding sensor 103 (such as a seismic sensor) for detecting subterranean features. Sensor 103 may be deployed intermittently (e.g., every other section) throughout streamer 102 in one example. In some embodiments, each section may have a corresponding sensor 103 for detecting subterranean features.

In the ensuing discussion, reference is made to seismic sensors. Note, however, in other implementations, the sensors used for detecting subterranean features may include any suitable sensors or sensing equipment. Note also that the arrangement in FIG. 2 is an example arrangement. Different arrangements may be used in other implementations. For example, the recording sensors may be within 10's of meters to the towing vessel Global Navigation Satellite System (“GNSS”) antenna. Streamer 102 may also include additional equipment that is not shown in FIG. 2, for example, one or more data storage devices (e.g., data storage device 106) as is discussed in further detail below.

Section 200A may further include a second sensor 202A, which in some embodiments is a depth sensor to detect the depth of the section of the streamer 102 in the body of water 108. Each of the other sections 200B, 200C depicted in FIG. 2 also includes a corresponding second sensor 202B, 202C (e.g., depth sensors).

Section 200A may further include steering device 204 to help steer streamer 102 in the body of water. Steering device 204 may include control surfaces 206 (in the form of blades or wings) that may be rotatable about a longitudinal axis of streamer 102 to help steer streamer 102 in a desired lateral direction. Steering device 204 may be provided intermittently (e.g., every other section) throughout streamer 102.

In some implementations, steering device 204 may include a battery (or other power source) 208 that may be used to power the steering device 204. Battery 208 may also be used to power the depth sensor 202A in the section 200A, as well as depth sensors 202B, 202C in other sections 200B, 200C that are relatively close to the section 200A containing the steering device 204. Power from the battery 208 may be provided over electrical conductor(s) 210 to the depth sensors 202A, 202B, 202C. Battery 208 may also be configured to power a data storage device (e.g., 106, 300, etc.) and in some cases battery 208 may be included within the data storage device. In alternative implementations, power may be provided from an alternative source, such as from the sea vessel 100, solar charger associated with a buoy, over an electrical cable 212 (or fiber optic cable) that may be routed through the streamer 102. To derive power from a fiber optic cable, each sensor 202 would include a conversion circuit to convert optical waves into electrical power. An alternative source of power may include a wave powered generator. A more thorough discussion of wave generated power may be found in U.S. Patent Publication 2009/0147619, which is incorporated by reference herein in its entirety. Accordingly, the data storage device described herein may include a battery to store such wave motion generated power.

In accordance with some embodiments, depth sensors 202 (202A, 202B, 202C shown) may be used to detect which sections 200 of streamer 102 are deployed in the body of water 108. Depth sensors 202 may provide data regarding whether corresponding sections are in the body of water 108 by communicating the data over a communications link (e.g., electrical or fiber optic cable) 212 that is run along the length of the streamer 102 to the reel 104 on the sea vessel 100 and/or to data storage device 106. The data provided from depth sensors 202 may be received at and stored within data storage device 106.

Referring now to FIG. 3, an embodiment depicting data storage device 300 is shown. Data storage device may be located in any suitable position along and/or within streamer 102 (e.g., see data storage device 106 shown in FIG. 1). Data storage device 300 may include a housing 302 having at least one attachment mechanism 304 configured to removably attach housing 302 to streamer 102. Although, the example data storage device 300 shown in FIG. 3 has two attachment mechanisms 304a and 304b, this is provided merely by way of example. Data storage device 300 may include various types of circuitry and storage elements examples of which are shown in FIG. 5. For example, data storage device 300 may include processing circuitry included within housing 302. The processing circuitry may be configured to receive information associated with the subterranean survey from one or more sensors (such as those discussed above). Data storage device 300 may further include one or more memory devices included within housing 302. The memory devices may be configured to store the information associated with the subterranean survey for subsequent use.

Housing 302 may be made out of any material suitable for use in body of water 108. For example, housing 302 may be constructed out of a metallic material and may be waterproof in order to prevent contamination of the electrical components included within housing 302. Other materials may include, but are not limited to, plastics, ceramics, etc. Housing 302 may also be constructed in a manner so as to be able to withstand fluctuations in pressure such as those that may be encountered within body of water 108. In some embodiments, housing 302 may include one or more wet-mateable connectors configured to interface with streamer 102. Housing 302 may include any number of shapes and configurations. In one particular embodiment, housing 302 may have a cylindrical configuration and/or may have a diameter similar to that of streamer 102 (e.g., no larger than that of streamer 102).

As discussed above, data storage device 300 may include an attachment mechanism 304 configured to removably attach data storage device 300 to towable streamer 102. In this way, attachment mechanism 304 may utilize any suitable method of attachment. For example, in some embodiments and as shown in FIG. 3, attachment mechanism 304 may include a screw fitting, which may be associated with housing 302. In this particular embodiment, attachment mechanisms 304A and 304B are shown on each end of housing 302. Accordingly, data storage device 300 may be affixed to one or more streamer sections (e.g., streamer section 200A, 200B, 200C, etc).

It should be noted that the data storage device described herein may be affixed to the streamer using any suitable technology. Some of these may include, but are not limited to, latches, straps, magnets, hooks, fasteners, screws, etc. These attachment mechanisms may be located in any suitable position with regard to housing 302.

In some embodiments, data recorded using data storage device 300 may be transferred to a data processing center by downloading data from data storage device 300 either while affixed to or after removal from the streamer. In this way, data storage device 300 may be disconnected from streamer 102 and the physical unit transferred to the data processing center for data transfer.

Referring now to FIG. 4, an embodiment depicting a streamer 400 including data storage device 402 attached to two sections of streamer 400 is shown. It should be noted that streamer 400 may be towable or may be located in a semi-permanent location (e.g., ocean bottom cable, etc.). In this particular embodiment, data storage device 402 is connected to streamer section 400A and streamer section 400B. Each of streamer sections 400A and 400B may include mating sections, which may be configured to interface with attachment mechanisms 404A and 404B. For example, in this particular embodiment, streamer sections 400A and 400B may include corresponding threaded portions that may be configured to mate with attachment mechanisms 404A and 404B.

Embodiments of the seismic streamer disclosed herein may require a physical connection to deploy and tow as the presence of data storage device 106 may not involve a power and communication means between the vessel and the streamer. In some embodiments, the streamers described herein may be deployed by attachment to a rig or other stationary platform near a reservoir as opposed to the vessel embodiment depicted in FIG. 1.

In this way, in some embodiments, the data storage device described herein may be deployed on the ocean bottom for ocean bottom acquisition and left semi-permanently. Accordingly, the processing circuitry included within the device may enable underwater high speed communications between the data storage device and a second device. In this type of arrangement and in addition to those discussed herein, power may be supplied from a subsea production power grid or surface platform such as a vessel or buoy. In this way, data may be harvested from the data storage device using underwater high speed communication systems (e.g., Bluecomm). Accordingly, power for data transmission may be maintained locally in a battery pack that may be changed out during data harvesting or supplied by the data harvesting vehicle, such as a remotely operated underwater vehicle (“ROV”). Wet mate-able connectors may also be used to both, recharge or change out, local batteries and harvest data from the data storage device (e.g., using an ROV).

In some embodiments, streamer neutral buoyancy may be achieved using weights or floats depending on the streamer density in the local water column. Depth keeping birds may be contemplated that require much less power due to reduced tension of the towed streamer.

Several towing configurations may be considered depending on the number of streamers being towed. In one particular implementation, one tow point may be connected to the towing vessel. In some embodiments, the towing cable may be connected to a hydro dynamically efficient horizontal spreader to which several streamers are attached. The spreader may be held at the target towing depth by attachment to surface floats attached to the towing frame on either side, or with buoyancy units attached to the towing frame. Another towing configuration is for a deflector device to be attached to each towing member ahead of the streamer. The deflector may provide a set wing angle to give it a cross line distance and depth at the towing speed.

In some embodiments, portions of a streamer may have varying degrees of rigidity. For example, and referring again to FIGS. 1-2, section 200A may have a first rigidity while section 200B may have a second rigidity, which may be greater or less than that of first section 200A. The more rigid portion may be located at any suitable location associated with streamer 102. For example, the more rigid portion may be located externally, internally, in a combination of external and internal portions. The rigid component may be built into the streamer core or other internal location, or may be located at the perimeter of the streamer. The degree of rigidity may depend on what additional buoyancy is used with the streamer in areas between rigid reinforcement and the requirement for changing the shape of the streamer during storage.

Various materials exist that have the property of being flexible when subjected to adequate bending forces yet substantially rigid when subjected to moderate bending forces. One parameter involves the amount of force needed to bend the substantially rigid streamer. This force may be more than the force exerted by gravity over the length of streamer between fixed buoyancy forces are used to keep the streamer in the horizontal. Yet the rigidity of the streamer should not be such that deforming the streamer to fit into a storage space involves forces that could result in injury to persons that could be impacted by the streamer rigid restoring force. Some materials that are known to be partially rigid yet bendable may include, but are not limited to, bamboo, various polyvinyl chloride compounds and temperature varying rigid materials such as graphene. In some instances, the particular materials selected may be based upon, at least in part, temperature, conductivity, absorption and dissipation properties. While the mechanisms to achieve a required bend radius for a streamer while being able to maintain straightness in the horizontal are many, one particular requirement for seismic acquisition is straightness. In some embodiments, the streamer may be permanently rigid and solutions for storing a rigid streamer can be employed, removing the requirement for flexibility. The rigid reinforcement element should be selected so it does not degrade the seismic signal recording properties of the streamer section. Accordingly, the material used should not transfer the signal and thus should be made of material that does not allow propagation in the seismic bandwidth.

Referring now to FIG. 5, an embodiment depicting an example of a computing device that may be associated with data storage device 106 and 300 is provided. Computing device 550 may include a processor 552, memory 564, an input/output device such as a display 554, a communication interface 566 and a transceiver 568, among other components. The device 550 may also be provided with a storage device, such as a microdrive or other device, to provide additional storage. Each of the components 550, 552, 564, 554, 566 and 568, may be interconnected using various buses, and several of the components may be mounted on a common motherboard or in other manners as appropriate.

Processor 552 may execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

In some embodiments, processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

In some embodiments, memory 564 may store information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry. Communication interface 566 may provide for communications under various modes or protocols, such as GSM voice calls, SMS, EMS, or MMS speech recognition, CDMA, TDMA, PDC, WCDMA, CDMA2000, Bluecomm, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) and/or GNSS (Global Navigation Satellite System) receiver module 570 may provide additional navigation and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550. Various additional and/or alternative components may also be included, such as those necessary to enable undersea communications.

The flowchart and block diagrams in the figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in any embodiment described herein, the term “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment or embodiment herein may be implemented in software, firmware, hardwired circuitry and/or any combination thereof.

The terminology used herein is for the purpose of describing particular embodiments and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the Seismic Streamer System described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A method of performing a marine survey, comprising:
deploying, into a body of water, a towable streamer including one or more sensors for performing a subterranean survey;
receiving, from the one or more sensors, information relating to the subterranean survey at a data storage device housed within a portion of the towable streamer; and
storing the information within the data storage device.

2. The method of claim 1, wherein the data storage device is removably attached to the towable streamer.

3. The method of claim 1, wherein the data storage device includes a cylindrical housing.

4. The method of claim 1, wherein the information is received from a particle motion sensor.

5. The method of claim 1, wherein the one or more sensors include at least one of depth sensors, acoustic sensors, and seismic sensors.

6. The method of claim 1, wherein the towable streamer includes at least one portion having a rigidity greater than that of a less rigid portion of the towable streamer.

7. The method of claim 1, wherein the towable streamer has a length of 30 meters or less.

8. The method of claim 1, wherein deploying the towable streamer includes one of deploying the streamer towed by a sea vessel and deploying a seabed cable laid on a sea floor.

9. A marine survey apparatus comprising:
a towable streamer to be affixed to a vessel and deployed into a body of water;
one or more sensors attached to the towable streamer, the one or more sensors to receive information associated with a subterranean survey;
a data storage device housed within a portion of the towable streamer, the data storage device to store the information associated with the subterranean survey.

10. The apparatus of claim 9, wherein the data storage device includes an attachment mechanism to removably attach the data storage device to the towable streamer.

11. The apparatus of claim 10, wherein the attachment mechanism includes a screw fitting.

12. The apparatus of claim 9, wherein the towable streamer includes at least one portion having a rigidity greater than that of a less rigid portion of the towable streamer.

13. The apparatus of claim 12, wherein the at least one portion having a rigidity greater than that of a less rigid portion is external to the towable streamer.

14. The apparatus of claim 9, wherein the towable streamer has a length of 30 meters or less.

15. A data storage device for use in a marine survey comprising:
a housing having at least one attachment mechanism to removably attach the housing to a streamer;
a processor to receive information associated with a subterranean survey from one or more sensors, the processor included within the housing; and
a memory device included within the housing to store the information associated with the subterranean survey.

16. The data storage device of claim 15, wherein the processor enables underwater high speed communications between the data storage device and a second device.

17. The data storage device of claim 15, wherein the housing includes a wet-mateable connector to interface with the streamer.

18. The data storage device of claim 15, wherein housing is cylindrical and includes a diameter no larger than a diameter of the streamer.

19. The data storage device of claim 15, wherein the streamer is at least one of vertically deployed, horizontally deployed or towable.

20. The data storage device of claim 15, further comprising a battery to store wave motion generated power.
